(19) United States
(12) Patent Application Publication
(10) Pub. No.: US 2005/0189665 A1
(43) Pub. Date: Sep. 1, 2005

(54) Method for producing light transmitting plate

(75) Inventor: Yoshiki Nishigaki, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/061,576

(22) Filed: Feb. 22, 2005

(30) Foreign Application Priority Data
Feb. 24, 2004 (JP) 2004-047437

(51) Int. Cl. B29D 11/00

(52) U.S. Cl. 264/1.1; 264/2.5; 264/328.1

(57) ABSTRACT

A method for producing a large-size light transmitting plate is provided. The method comprising (1) connecting a cylinder of an injection device with a cavity in a mold; the mold having a space with a non-uniform height and comprising a mold body and a cavity block, the cavity block having a fluid channel, the fluid channel being connected with a fluid switching means for changing a fluid medium and allowing a heating medium and a cooling medium, (2) passing the heating medium through the fluid channel; (3) supplying the resin to the cylinder; (4) filling the molten resin into the cavity; and (5) passing the cooling medium through the fluid channel after the filling of the cavity, to cool the cavity surface to a temperature lower than the glass transition temperature of the resin.

### BACKGROUND OF THE INVENTION

1. Field of the Invention

The present invention relates to a method for producing a light transmitting plate, which can be used as a back light device for a liquid crystal display.

2. Description of the Related Art

A light transmitting plate is used as an optical element for transmitting light from a light source arranged on a lateral face of the plate to a liquid crystal display surface in a liquid crystal displays for a notebook-type personal computer, a desk-top personal computers, a television set and the like. FIG. 1(a) and FIG. 1(b) are sectional views schematically showing arrangement of liquid crystal displays and light transmitting plates. A back light device, which is arranged on the back face of a liquid crystal display 1, mainly comprises a light transmitting plate 2 or 3, a reflection layer 4 arranged on the back face of the light transmitting plate 2 or 3, a light diffusion layer 5 arranged on the front face of the light transmitting plate 2 or 3 (facing the liquid crystal display), a light source 7 arranged on the lateral face(s) of the light transmitting plate 2 or 3, and a reflector 8 for transmitting light from the light source 7 into the light transmitting plate 2 or 3. The light from the light source 7 is reflected by the reflector 8 to enter into the light transmitting plate 2 or 3. The incident light is reflected by the reflection layer 4 and then is emitted from the front face of the light transmitting plate 2 or 3, while passing through the light transmitting plate 2 or 3. Herein, the light is uniformly emitted from the entire front face due to the presence of the light diffusion layer 5, to serve as illumination for the liquid crystal display 1. A cold cathode tube is typically used as the light source 7. It is also known to use a prism sheet for regulating a diffused light loss as well as light directivity. A pattern such as dots or lines may be provided on the rear face of the light transmitting plate 2 or 3 by printing or the like so that light is emitted uniformly from the front face.

FIG. 1(a) shows an arrangement to be applied to relatively small-sized display having a diagonal length up to about 14 inches, for notebook personal computers and the like. The light transmitting plate 2 is formed in a wedge-like shape having a thickness sequentially changing from about 0.6 mm up to about 3.5 mm. FIG. 1(b) shows an arrangement to be applied to a larger-sized display for desktop personal computers, liquid crystal television sets and the like. The light transmitting plate 3 is formed in a sheet-like shape having almost uniform thickness.

A methacrylic resin is typically used for the light transmitting plate 2 or 3. The wedge-like shaped light transmitting plate 2 having a relatively small area, as shown in FIG. 1(a), is produced by injection molding, whereas a sheet-like shaped light transmitting plate 3 having a relatively large area, as shown in FIG. 1(b), is produced by cutting-out from a resin sheet.

For example, a large-sized light transmitting plate having a diagonal length exceeding 14 inches is conventionally produced by cutting-out from a methacrylic resin sheet.

In contrast with this, methods for producing a large-sized light transmitting plate by injection-molding using a molten resin have been proposed in Japanese Laid-Open Patent Publication No. 2000-229343, Japanese Laid-Open Patent Publication No. 2002-011769, Japanese Laid-Open Patent Publication No. 2002-046259, Japanese Laid-Open Patent Publication No. 10-128783, Japanese Laid-Open Patent Publication No. 11-245256 and the like.

These methods seem to be preferred for obtaining a large-sized light transmitting plate with non-uniform thickness, having a thickness distribution (for example, a thickness sequentially changing from one side to the other side) as shown in FIG. 1(a).

However, the large-sized light transmitting plate with non-uniform thickness obtained in these injection-molding methods may have poor appearance such as a short shot, sink and weld. Moreover, in the case of forming a rough pattern on the plate (molded article) with a cavity having that pattern thereon, copying of the rough pattern from the cavity surface to the plate (molded article) is insufficiently performed. Further, in the conventional injection moldings, the larger the light transmitting plate with non-uniform thickness, the more tendencies of inaccurate thickness or dimensions and of mold warping.

### SUMMARY OF THE INVENTION

In consideration of the foregoing circumstances, the present inventors conducted intense studies for developing a method, in which a large-sized light transmitting plate with non-uniform thickness having a diagonal length of not smaller than 14 inches (355 mm) is produced by molding a molten resin, required performance as a light transmitting plate can be satisfied, and at the same time, a reflection layer pattern or a light diffusion pattern can be formed on the surface of the light transmitting plate using a cavity having the pattern thereon. As a result of their studies, the present invention has been accomplished.

The present invention provides a method for producing a light transmitting plate, the method comprising the steps of:
(1) connecting a cylinder of an injection device with a cavity in a mold having a diagonal length of not smaller than 14 inches (355 mm);
the mold having (i) a space with a non-uniform height corresponding to a thickness of the plate with a ratio of the largest thickness to the smallest thickness of the plate in the range of 1.1 to 8, and (ii) comprising a mold body and a cavity block for forming a cavity surface,
the cavity block having a thermal conductivity higher than that of the mold body, and having a fluid channel in the interior thereof,
the fluid channel being connected with a fluid switching means for changing a fluid medium to be passed therethrough, and allowing a heating medium and a cooling medium to pass alternately through the fluid switching means, to regulate a temperature of the mold,
(2) passing the heating medium through the fluid channel so as to heat the cavity surface to a temperature in the vicinity of or higher than a glass transition temperature of a resin to be filled into the cavity, and also so as to heat the cavity surface to a temperature of not lower than the glass transition temperature when the supply of the resin is finished;
(3) supplying the resin to the cylinder and melting the resin;
(4) filling the molten resin into the cavity; and
(5) passing the cooling medium through the fluid channel after the filling of the cavity, to cool the cavity surface to a temperature lower than the glass transition temperature of the resin, thereby to obtain a light transmitting plate with an non-uniform thickness.

According to the present invention, it is possible to produce even a light transmitting plate with non-uniform thickness having a diagonal length not smaller than 14 inches (355 mm), e.g. a large-sized light transmitting plate having the smallest thickness of not less than 2 mm, and the largest thickness in the range of from not less than 5 mm to not more than 16 mm, with superior size accuracy, dimensional stability, transparency and the like, without a defect such as a sink which tends to occur in the thin part. Further, during the above production, a rough pattern, corresponding to a reflection layer or a light diffusion layer on the emission layer side of a molded article (plate), is formed on at least one of the mold cavity surfaces, and the pattern is copied to the surface of the molded article (plate). With this configuration, since a reflection layer pattern and/or a light diffusion layer pattern can be directly formed on the molded article, a printing process can be omitted and the production cycle can thus be reduced, thereby leading to reduction in total production cost of a light transmitting plate.

### BRIEF DESCRIPTION OF THE DRAWINGS

FIG. 1(a) and FIG. 1(b) are sectional views schematically showing arrangement of liquid crystal displays and light transmitting plates. Specifically, FIG. 1(a) is a view showing one example using a wedge-like shaped light transmitting plate; and FIG. 1(b) is a view showing one example using a sheet-like, flat light transmitting plate.

FIG. 2(a) to FIG. 2(g) are oblique views schematically showing examples of light transmitting plates with non-uniform thickness in the present invention.

FIG. 3 is a vertical sectional view schematically showing one example of a molding machine which may be used in the present invention.

FIG. 4 is a vertical sectional view schematically showing one example of a mold and a mold-cramping mechanism in the case of employing a toggle-type mold-cramping mechanism.

FIG. 5(a) to FIG. 5(c)(including FIG. 5(c1) and FIG. 5(c2)) are views schematically showing the periphery of a mold cavity and a light transmitting plate obtained from the cavity in the case of arranging two gates. Specifically, FIG. 5(a) is a vertical sectional view showing the periphery of the mold cavity; FIG. 5(b) is a horizontal sectional view of the same; FIG. 5(c1) and FIG. 5(c2) are a vertical sectional view and a front view of a light transmitting plate obtained from the mold, respectively.

FIG. 6 is an oblique view schematically showing a figuration of a light transmitting plate taken out of a mold in Example 1.

### DETAILED DESCRIPTION OF THE PREFERRED EMBODIMENTS

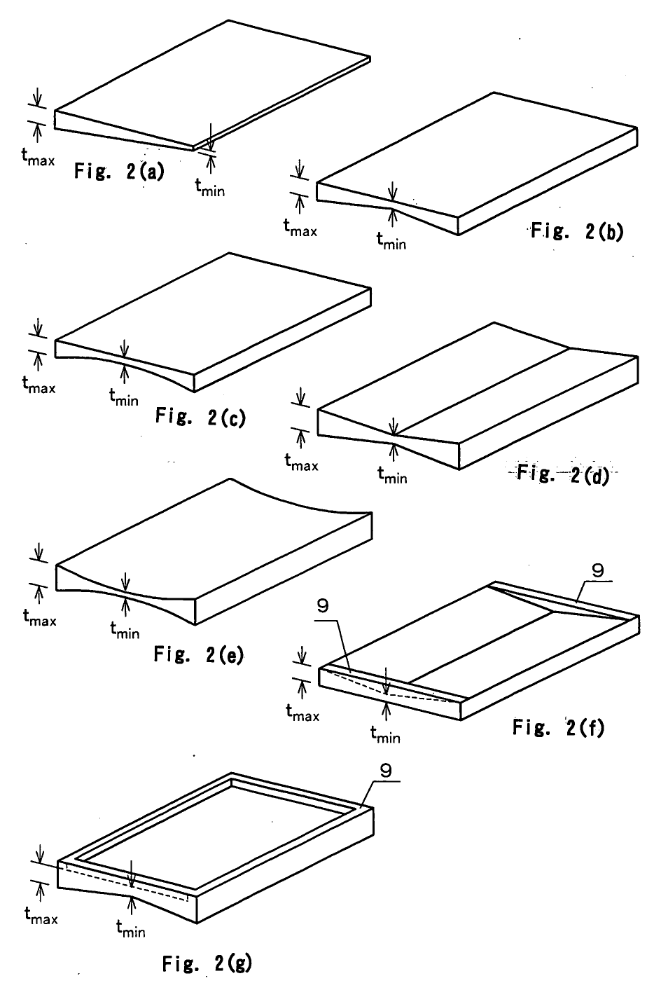

In the present invention, a large-sized light transmitting plate with a non-uniform thickness, having a diagonal length of not smaller than 14 inches, can be produced. The light transmitting plate may have a ratio of the largest thickness to the smallest thickness thereof in the range of from 1.1 to 8. FIG. 2(a) to FIG. 2(g) are oblique views schematically showing examples of light transmitting plates which can be obtained in the present invention. In FIG. 2(a) to FIG. 2(g), the largest thickness (tₘₐₓ) part and the smallest thickness (tₘᵢₙ) part are also shown in each figures. The smallest thickness (tₘᵢₙ) is preferably not less than 2 mm, and the largest thickness (tₘₐₓ) may be up to about 16 mm.

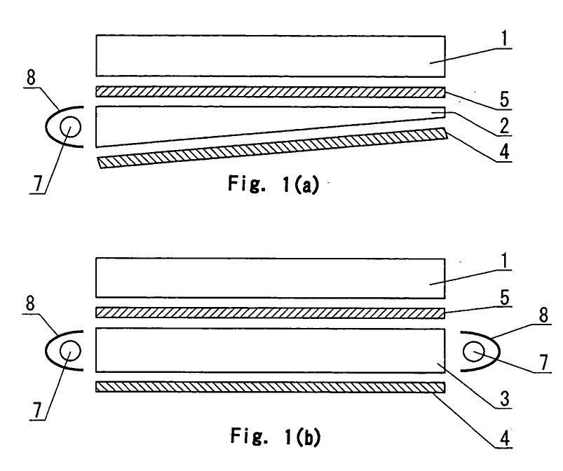

FIG. 2(a) shows an example of a figuration of a wedge-like shaped light transmitting plate. One of the longer edge side of the plate has the largest thickness. The thickness of the plate sequentially decreases from the one longer edge side toward the other longer edge side, and the other longer edge side has the smallest thickness. The figuration of the light transmitting plate is the same as that of the light transmitting plate 2 shown in FIG. 1(a). In the case of using this plate, a light source lamp may be placed on the longer edge with the largest thickness.

FIG. 2(b) shows an example of a figuration of a light transmitting plate having a recess formed by cutting off a triangle prism from one surface (the lower surface hidden in FIG. 2(b)) of a flat plate. With such a recess, the center line part of the longitudinal direction of the lower surface has the smallest thickness, whereas each longer edge side in parallel with the center line has the largest thickness. The recess may be allowed to have a certain curvature. In the case of using the plate in FIG. 2(b), a light source lamp may be placed on each of the longer edges with the largest thickness.

FIG. 2(c) shows an example of a figuration of a light transmitting plate having a curved recess in one surface (the lower surface hidden in FIG. 2(c)) of a flat plate. Also in the case of using this plate, with such a recess formed in the surface, the center line part of the longitudinal direction of the lower surface has the smallest thickness, whereas each longer edge side in parallel with the center line has the largest thickness.

FIG. 2(d) shows an example of a figuration of a light transmitting plate having a recess in the form of a triangle prism, as shown in FIG. 2(b), on each of surfaces of a flat plate. Also in the case of using this plate, due to such a recess formed in each surface, the center line part of the longitudinal direction of the plate has the smallest thickness, whereas each longer edge side in parallel with the center line has the largest thickness.

FIG. 2(e) shows an example of a figuration of a light transmitting plate having a curved recess, as shown in FIG. 2(c), on each surface of a flat plate. Also in the case of using this plate, due to such a recess formed in each surface, the center line part of the longitudinal direction of the plate has the smallest thickness, whereas each longer edge side in parallel with the center line has the largest thickness.

FIG. 2(f) shows an example of a figuration of a light transmitting plate having a shape such that a triangle prism is cut off from one surface (the upper surface in FIG. 2(f)) of a flat plate, as in FIG. 2(b), and ribs 9 and 9 are then formed on the two shorter edges on the recess-formed surface. Also in the case of using this plate, the center line part of the longitudinal direction of the recess-formed surface has the smallest thickness, whereas each longer edge side in parallel with the center line has the largest thickness.

FIG. 2(g) shows an example of a figuration of a light transmitting plate having a shape such that a triangle prism is cut off from one surface (the lower surface hidden in FIG. 2(g)) of a flat plate, as in FIG. 2(b), and the rib 9 is formed on the entire periphery of the opposite flat surface. Also in the case of using this plate, the center line part of the longitudinal direction of the recess-formed surface has the smallest thickness, whereas each longer edge side in parallel with the center line has the largest thickness. When the rib 9 is present as shown in FIGS. 2(f) and (g), the largest thickness (tₘₐₓ) and the smallest thickness (tₘᵢₙ) are determined by excluding the rib portion. The rib 9 can prevent occurrence of warping of the plate due to water absorption after molding.

In FIG. 2(a) to FIG. 2(e) and FIG. 2(g) among the above examples, the lower surface hidden in the figures may be typically arranged so as to serve as the reflection layer 4 in FIG. 1(a) and FIG. 1(b). Therefore, in the case of forming a reflection layer pattern, the pattern may be formed on the lower surface of the light transmitting plate. Meanwhile, in FIG. 2(f), the upper surface may be arranged as the reflection layer 4 shown in FIG. 1. Therefore, in the case of forming a reflection layer pattern on the light transmitting plate of FIG. 2(f), the pattern may be formed on the upper surface thereof. Further, in the case of forming a light diffusion layer pattern, the pattern is formed on the surface opposite to the reflection-layer-side surface.

In the present invention, a large-sized light transmitting plate with irregular thickness, namely non-uniform thickness, having a diagonal length of not smaller than 14 inches, can be produced by directly molding a molten resin. The ratio of the largest thickness (tₘₐₓ) to the smallest thickness (tₘᵢₓ) of the light transmitting plate may be in the range of from 1.1 to 8. In the case of using such a large-sized light transmitting plate, it is preferred that the largest thickness part where a light source is placed is reasonably large, in order to secure an amount of light to be emitted toward such a large-sized liquid crystal display. The method of the present invention is particularly effective for use in production of a light transmitting plate with a non-uniform thickness, having the largest thickness (tₘₐₓ) of not smaller than 5 mm, and particularly not less than 8 mm. In the present invention, a large-sized light transmitting plate can be produced even if the plate has a large thickness and a large variation degree of thickness, namely a large thickness with the ratio (tₘₐₓ/tₘᵢₙ) of the largest thickness (tₘₐₓ) to the smallest thickness (tₘᵢₙ) of not less than 2. As for such a light transmitting plate, the largest thickness (tₘₐₓ) can be in the range of about 5 mm to about 16 mm, and the smallest thickness (tₘᵢₙ) is preferably about 2 mm or larger.

A resin as a raw material to be used may be a transparent resin having physical properties required for a light transmitting plate. Examples of such a resin may include a variety of melt-moldable thermoplastic resins, such as a methacrylic resin, a polycarbonate resin, a polystyrene resin, a copolymer resin (MS resin) of methyl methacrylate and styrene, an amorphous cycloolefine-based polymer resin, a polypropylene resin, a polyethylene resin, a high density polyethylene resin, a copolymer resin (ABS resin) of acrylonitrile, butadiene and styrene, a polysulfone resin, and a thermoplastic polyester resin. The methacrylic resin is a polymer mainly containing polymerization unit derivered from methyl methacrylate. Examples of the polymer may include a homopolymr of methyl methacrylate, and a copolymer of methyl methacrylate and such a small amount as up to about 10% by weight, of a monomer such as alkyl acrylates (e.g., methyl acrylate and ethyl methacrylate). Further, each of those transparent resins may contain, if necessary, a mold release agent, an ultraviolet absorber, a pigment, a retarder, a chain transfer agent, an antioxidant, a fire retardant, and the like.

In the present invention, a large-sized light transmitting plate can be produced by a method comprising the steps of melting a transparent resin in a cylinder of a injection device, filling the resultant molten resin in a mold cavity and then molding the resin. During the molding, a pattern may be formed on the resultant molded article with the cavity having that pattern thereon. Examples of such a method may include an injection molding method, an injection compression molding method, a flow molding method, and a method similar to those methods. A molding machine to be used in the above method may have almost the same constitution as that of a conventional injection-molding machine. However, the injection-molding machine used in the present invention may have a mold temperature regulating mechanism. In the present invention, it is preferred that the mechanism works so that the cavity surface in the mold is heated to a temperature in the vicinity of or higher than the glass transition temperature of the resin to be filled into the cavity, prior to the filling of the resin into the cavity, and the cavity surface is promptly cooled to a temperature lower than the glass transition temperature of the resin after completion of the filling, thereby regulating the mold temperature.

The mold temperature regulating mechanism is described in more detail below. A fluid channel (which is in the interior of the mold cavity) for passing a medium therethrough is formed in the vicinity of the cavity surface. A fluid switching means for changing a fluid medium to be passed therethrough is connected with the fluid channel. A heating medium and a cooling medium (coolant) can be alternately passed through the fluid channel and the fluid changing means, to regulate a temperature. Such a temperature regulating technique by a so-called heating medium/coolant changing method may be employed in the present invention. The mediums can be switched, for example, by setting a timer, changing a switch valve or the like. By heating or cooling when needed in the manner described above, cooling-heating cycle molding can be performed. Examples of the heating medium and the cooling medium include oil for a machine, water, steam and the like. Among them, water-based liquid, e.g. water as the cooling medium and pressurized water as the heating medium, is preferably used.

In the cooling-heating cycle molding as thus described, a temperature of the mold can be raised and lowered for a short period of time. In this case, the mold cavity surface is preferably made from a metal having high thermal conductivity. Specifically, it is preferred that a cavity block constituted of a metal having high conductivity is employed and arranged to form a cavity surface, and a fluid channel is then provided in the cavity block. A heating medium and a cooling medium are alternately passed through the fluid channel to regulate the temperature of the mold. The mold body may be constituted of a steel material, and for the cavity block, there is used a metal having a thermal conductivity higher than that of the steel metal constituting the mold body. Specifically, copper or a copper alloy is preferably used as the metal to constitute the cavity block. In particular, it is preferable to use beryllium-copper, namely a copper alloy containing beryllium in an amount of about 0.3 to 3% by weight, which may have thermal conductivity three to six times as high as that of a typical steel material.

In the case that the cavity surface (a surface to come into contact with a resin filled in the cavity) has a smooth mirror face, it is effective to plate the surface for obtaining a superior mirror face and improving mold releasing properties. Examples of the material to be plated may include titanium carbide (TiC), titanium nitride carbide (TiCN), titanium nitride (TiN), tungsten carbide (W₂C), chromium (Cr), nickel (Ni), and nickel-phosphorous (Ni.P). It is also effective to polish the surface after being plated.

Also, in the present invention, a rough pattern such as dots or lines may be previously formed on at least one mold cavity surface, and copied to the resin filled in the cavity so as to form the pattern on a resulting molded article (plate). The pattern can be used as a reflection layer pattern for reflecting light that is transmitted through a light transmitting plate to a liquid crystal display side, a light diffusion pattern for diffusing and emitting light on the front side (emission side) of a light transmitting plate, and the like. A reflection layer pattern and a light diffusion layer pattern on the front side can be also formed simultaneously by forming a rough pattern on each of the cavity surfaces.

This rough pattern can be observed by an optical simulation. The pattern may be a known pattern having a function capable of diffusing incidence light, such as a circle, triangle, or square pattern, a dotted pattern formed by a combination thereof, a slit-like grooved pattern or a mat-like embossed pattern. Examples of the method for forming the rough pattern may include a stamper method, a sand blast method, an etching method, a laser processing method, a milling method and an electroforming method. For example, the reflection layer pattern for replacement of printing may be formed as follows. A density and dimensions of the rough pattern may be increased with increase in distance from a cold cathode tube as a light source, so as to allow the reflection layer as a whole to uniformly diffuse emission light. If the rough pattern is made of dots, a diameter of each dot and a density of the dots are typically increased with increase in distance from the incident side of a light source.

Such a rough pattern can be made directly on the cavity surface. However, for facilitating pattern formation as well as replacement with a different pattern, it is preferable to previously prepare a thin cavity plate having a rough pattern formed on the surface thereof, and then insert the prepared cavity plate into the mold to be set therein, or to be bonded to the cavity surface. A material for the cavity plate may be a material suitable for forming the rough pattern, and examples thereof may include a stainless steel plate, a nickel plate and a copper alloy plate such as a beryllium-copper plate. Further, the thickness of the cavity plate is preferably as small as possible, and is for example selected as appropriate from the range of about 0.1 to 5 mm.

In the present invention, a cavity block is provided in a mold to form a cavity surface. For example, a thin layer is formed on or bonded to the surface of the cavity block itself, such as the case of plating the cavity surface to come into contact with the molten resin and the case of arranging the cavity plate on the cavity surface, as described above, besides the case of using one surface of the cavity block as it is as the cavity surface.

In order to sufficiently fill a molten resin even at the smallest thickness (thin) part of a mold cavity, it is preferred to fill the molten resin into the mold cavity at an appropriate rate. Therefore, when the molten resin is allowed to flow from the cylinder to the mold cavity, it is preferred to pass the molten resin through an inlet (gate) of the mold cavity so that the viscosity of the molten resin is in the range of 50 to 5000 Pa·sec. It is also preferred to fill the molten resin into the mold cavity at an injection ratio in the range of 1 to 30 cm³/sec per one molded article. In the case of forming a rough pattern on at least one of the mold cavity surfaces and copying the rough pattern from the cavity surface to the molded article surface, filling the molten resin into the cavity at a relatively small rate as described above is effective for accurate copying of the rough pattern.

The term “injection ratio” here refers to an average injection rate from the start to the end of the filling. The injection ratio is more preferably in the range of 4 to 30 cm³/sec per one article. The molten resin is preferably filled into the mold at such a relatively slow rate for sufficiently supplying the molten resin even to the smallest thickness part of the mold cavity, to obtain a superior light transmitting plate with a non-uniform thickness. This is because, in such a case, occurrence of a sink on the plate can be sufficiently suppressed, and a rough pattern (if any, formed on the cavity surface) can be copied to the plate surface with high accuracy.

An extremely small injection ratio may cause poor appearance such as a short shot and a flow mark, and insufficient accuracy in thickness and dimensions. On the other hand, an extremely high injection ratio may cause occurrence of a sink and less accuracy in thickness and dimensions. The injection ratio can be determined by dividing a volume (cm³) of a product by the time (sec) that lapsed for filling of the molten resin, where the volume of the product is obtained by a weight of the product and a specific gravity of the resin. Even using the same mold, the weight of the product changes to a certain degree depending on the speed at which the molten resin is flown into the cavity, namely the filling time, and hence the most suitable injection ratio can be determined by conducting a simple pre-experiment.

A viscosity of the molten resin passing through the inlet of the mold is preferably low in view of moldability. However, lowering the viscosity of the molten resin may cause an excessive increase in temperature of the molten resin and an increase in injection ratio. Hence the lower limit of the viscosity is preferably about 50 Pa·sec. On the other hand, an excessively high viscosity of the molten resin may results in solidification of the molten resin before supplied throughout the mold cavity. Hence the upper limit of the viscosity is preferably about 5000 Pa·sec.

The viscosity of the molten resin at the inlet of the mold can for example be obtained as follows. First, a linear velocity at the inlet of the mold is measured based on an injection ratio (cm³/sec) and a sectional area (cm²) of the inlet of the mold according to the following formula (i). Next, a shear rate (sec⁻¹) of the resin at the inlet of the mold is simply calculated based on the above-obtained linear velocity and a thickness (cm) of the inlet of the mold according to the following formula (ii).
Linear velocity (cm/sec) at mold inlet=Injection ratio(cm³/sec)/Sectional area of mold inlet(cm²) (i)
Shear rate (sec⁻¹)=Linear velocity(cm/sec)/[thickness of mold inlet/2](cm) (ii)

And then, the viscosity of the molten resin at the obtained shear rate can be determined based on data concerning dependency of the viscosity of the resin on the shear rate, separately obtained by a capillograph test.

As a method for filling the molten resin into the cavity at a slow rate, there can for example be employed a method in which, using a normal injection molding machine, a resin is rotated by a screw arranged in a cylinder to be measured and accumulated, and while the melt condition of the resin is held, the screw is slowly driven forward to fill the molten resin into the mold cavity. Further, there can also be effectively employed another method in which, while a screw is rotated, a molten resin is filled into a mold cavity by forward driving force by the rotation (rotation-transfer function). In this case, a so-called flow molding method is advantageously employed. It is also possible to modify a ROM (Read Only Memory) for driving a screw in a conventional injection molding machine to a specification suitable for the above methods so as to be applied to the molding in the present invention.

Further, in the case of a product with particularly a large unevenness (non-uniform) degree of thickness, it might be difficult to fill a thin part of the cavity with the resin. However, the present invention can overcome the difficulty because it is not restricted to a conventional one-point gate system in which an inlet for the resin flowing into a cavity is provided in only one location, and can employ a multipoint gate system in which inlets of the mold are provided in two or more locations. It is said that in conventional injection molding the multipoint gate system should be avoided, since the multipoint system tends to make a so-called melting line (e.g., a weld line) on the surface of a molded article, which might essentially lead to poor luminance. However, in the present invention, especially when a pattern is formed on a molded article with the cavity having the pattern thereon at a mold temperature of not lower than the glass transition temperature of the resin, the multipoint gate system can be employed. In this case, the molten resin is not immediately solidified, and thus few or no melting line (namely a weld line) occurs. Accordingly, in the case of a product in a thin part of which a short shot tends to occur even with the injection ratio within the foregoing range, the generation of occurrence of a short shot can be suppressed by using the multipoint gate system in which inlets (gates) for filling a molten resin into the cavity are arranged in two or more locations.

Namely, in the present invention, the mold may have at least two gates to serve as inlets for filling the molten resin into the cavity. For example, when the cavity has a rectangular-plate shape with a non-uniform thickness, and the smallest thickness part of the cavity is formed in parallel with the longer sides of the cavity, then two gates for filling the molten resin into the cavity may be respectively provided so as to face each other at the thick parts (the parts in the vicinity of the vicinity of the thickest parts) of the shorter sides of the cavity. In this case, the smallest thickness part of the cavity may be formed along with the center line in parallel with the longer sides of the cavity.

One embodiment of the preferable processes for obtaining a molded article in the present invention is described below.

First, a heating medium having a temperature of not lower than a glass transition temperature of a resin to be molded, is passed through a fluid channel in the mold. Next, with the cavity surface heated to a temperature in the vicinity of the glass transition temperature, the resin is supplied into the cylinder and melted, and then is injection-filled into the mold cavity. Herein, as mentioned above, the mold surface temperature during the flowing of the molten resin into the mold cavity is preferably set at a temperature of not lower than the glass transition temperature of the resin to be molded. In consideration of the cycle, however, the temperature of the resin at the start of flowing of the resin into the cavity may be set at a temperature of not higher than the glass transition plate of the resin. In this case, the mold surface temperature is preferably set to be not lower than the glass transition temperature of the resin by the time when the succeeding holding pressure step (mentioned below) is started. When the filling of the resin into the mold is started, it is preferred to set the mold surface temperature to be in the range of from not lower than (Tg−25) ° C. to not higher than (Tg+25) ° C., and more preferably not lower than (Tg−10) ° C., wherein Tg ° C. represents the glass transition temperature of the resin. Further, the temperature regulating system to be used herewith is preferably a system such that the mold surface temperature can be raised and lowered for a shorter period of time.

The preferable mold surface temperature varies depending on the kind of a resin used, and it may be about 50 to 150° C. In the case of using a methacrylic resin, since the glass transition temperature thereof is about 105° C., the mold surface temperature is preferably about 105 to 130° C. The preferable injection temperature of the molten resin also varies depending on the kind of a resin used, and it may be about 170 to 300° C. In the case of using a methacrylic resin, the preferable injection temperature thereof is about 200 to 300° C., and more preferably about 220 to 270° C.

In the present invention, a molten resin may be filled from a cylinder into a mold cavity, while a screw in the cylinder is rotated. In this case, the resin is supplied into the cylinder by rotation-drive of the screw simultaneously with filling the molten resin into the mold cavity. Upon filling of the molten resin throughout the mold cavity, holding pressure is preferably applied. Before starting application of holding pressure, at the start of application of holding pressure, at a certain time point during application of holing pressure, or at the completion of application of holding pressure, a medium passing through the fluid channel in the mold may be changed to a cooling medium having a temperature lower than the glass transition temperature of the resin, and preferably not higher than a load deflection temperature, and then the cooling process is started. It is noted that the load deflection temperature of polymethyl metacrylate is in the range of from about 90° C. to about 105° C., depending on its grade.

After sufficient cooling of the molded article, the mold is opened to take out a molded article therefrom. It is preferable to set the time, required for changing the medium to a cooling medium through the flow channel in the mold, to the time from 20 seconds or less after completion of filling of the molten resin to the 10 seconds or less, and more preferably 5 seconds or less, after completion of filling of the molten resin.

It is further effective to apply pressure from the cavity surface side, namely compress from the mold side, in place of or in combination with application of holding pressure. In this case, the mold cavity is previously opened by weak mold cramping force or by one compression stroke, and with the cavity kept open, the molten resin is filled into the cavity, which may be compressed by increasing mold cramping pressure after, or immediately before, completion of filling. In such a condition, the medium through the fluid channel in the mold is changed to the coolant for cooling.

In filling the molten resin into the mold cavity, carbon dioxide may previously be injected into the mold cavity according to the disclosures of Japanese Laid-Open Patent Publication No. Hei 10-128783 and Japanese Laid-Open Patent Publication No. Hei 11-245256. It is also effective to apply the previous injection of carbon dioxide to a method of filling a molten resin into a mold cavity by transfer function generated by the screw rotation of a screw in an injection cylinder, or a method of filling a molten resin into a mold cavity at a very slow rate, as disclosed in Japanese Laid-Open Patent Publication No. 2002-011769 and Japanese Laid-Open Patent Publication No. 2002-046259. In production of an aimed light transmitting plate with uneven thickness in the present invention, application of the method of previously injecting carbon dioxide into the mold in combination with the mold temperature regulating mechanism is expected to exert further effects, including effective filling of the molten resin into the mold and potential lowering of a temperature of the molten resin to be supplied. When a rough pattern is formed on at least one cavity surface and then copied to a light transmitting plate, copy performance is expected to be further improved.

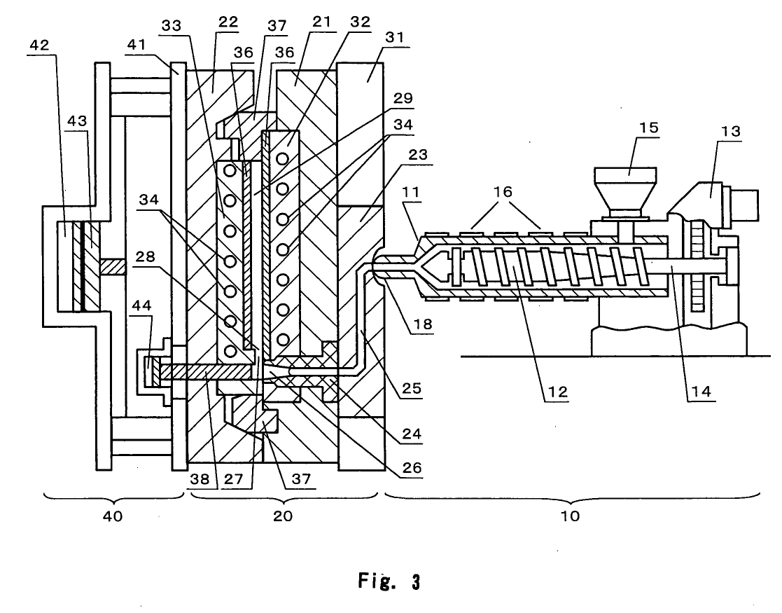

The molding method of the present invention is described below by reference to FIG. 3. FIG. 3 is a vertical sectional view schematically showing one example of a molding machine suitably used in the present invention. The device is mainly composed of an injection device 10, a mold 20 and a mold cramping device 40.

The injection device 10 comprises an injection cylinder 11, a screw 12 to be rotated and driven forward in the injection cylinder, a motor 13 for rotation-driving the screw, a ram mechanism 14 for moving the screw forward or backward, a hopper 15 for supplying a resin to the injection cylinder 11, heaters 16 and 16 placed on the outer surface of the injection cylinder, and an injection nozzle 18 present at the end of the injection cylinder, for injecting a molten resin.

A mold 20 comprises a fixed mold 21 and a movable mold 22. In the fixed mold 21, a heating barrel 23 for passing a molten resin injected from the injection nozzle 18, and a hot runner 25 placed in a hot tip bushing 24, and those have all been heated. At the end of the hot runner 25, a sprue 26 is formed which has a sectional area increasing in taper form toward the movable mold 22. The hot tip bushing 24 may have a configuration of a typical open-gate system. However, in order to prevent the resin from flowing backward from the gate, the hot tip busing 24 preferably has a configuration of a valve-gate system, wherein a gate is opened when necessary, and is closed when the opening of the gate is unnecessary as in production processes after the holding pressure application process.

A runner 27 is formed on a connecting face of the fixed mold 21 and the movable mold 22 along both molds 21 and 22. The runner 27 is connected with the sprue 26, the opposite-side end of which is a gate 28. The fixed mold 21 is connected with the movable mold 22 to form a cavity 29 for a molded article. The cavity 29 is connected with the gate 28. Therefore, in this example, the cavity 29 is connected with the cylinder 11 of the injection device 10 through the gate 28, the runner 27, the sprue 26 and the hot runner 25. The fixed mold 21 is fixed to a fixed plate 31, and a fixed-side cavity block 32 is placed on the cavity 29 side. On the other hand, the movable mold 22 is fixed to a movable plate 41, and a movable-side cavity block 33 is placed on the cavity 29 side. The movable plate 41 is moved forward or backward by a later-mentioned mold cramping device 40 to open or close the mold.

Fluid channels 34 and 34 for a heating medium and a coolant are formed in the interior of the fixed-side cavity block 32 and the movable-side cavity block 33 along the surface of the cavity 29. A mold surface temperature is raised or lowered according to an object during a molding cycle by passing a heating medium and a coolant alternately through the fluid channels 34 and 34 by temperature regulating device with a controller set therein. As described above, the fixed-side cavity block 32 and the movable-side cavity block 33 comprise a metal, such as a beryllium-copper alloy, having higher thermal conductivity than that of a metal (typically, a steel material) constituting the mold bodies 21 and 22.

The cavity 29-side surface of the fixed-side cavity block 32 and that of the movable-side cavity block 33 comprise the cavity plates 36 and 36, which form a rough pattern for a pattern of a reflection layer or a pattern of a light diffusion layer on either side or both sides of a light transmitting plate. The cavity plates are inserted in the mold, or bonded to the mold. The cavity plates 36 and 36 may be made of a material having high thermal conductivity such as a beryllium-copper alloy, or a plate, made of a stainless steel having a variety of rough patterns formed thereon, or the like, may be bonded to the surface of each of the cavity blocks 32 and 33 made of a metal having high thermal conductivity. The cavity plates 36 and 36 may be provided on the surface where a rough pattern is formed for a pattern of a reflection layer or a pattern of a light diffusion layer. For example, when the light transmitting plate has one surface with a rough pattern formed thereon and the other surface formed flat, the cavity plate 36 may be placed on the flat cavity surface, or the cavity blocks 32 or 33 may have a metal surface, or the cavity block 32 or 33 may have a plated surface.

The shorter the distance from the cavity surface to the fluid channels 34 and 34, the more preferable in view of temperature regulation efficiency. However, an extremely small distance from the cavity surface to the fluid channel 34 could lead to lack in strength of that part and insufficiency in uniformity of the cavity surface temperature. Therefore, it is generally preferable to set a distance between a position of the fluid channels 34 closest to the cavity surface and the cavity surface (the cavity surface of the cavity plate 36 in FIG. 3) to about 5 to 20 mm, although such a preferred distance range may be somewhat different depending on the number of fluid channels. This distance is preferably not smaller than 8 mm and not larger than 12 mm. In the case of a product with uneven thickness, a cooling ratio of a molded article differs between a thin part and thick part, to cause a difference in volume shrinkage, which tends to result in a difference in warping of a molded article as a whole. In order to make a volume shrinkage and warping of a molded article as a whole as uniform as possible, the distance from the cavity surface to the fluid channel 34 may be changed, or a diameter of the fluid channel 34 may be changed at a thin part and thick part. For example, a distance from the cabinet surface to the fluid channel in a position to become a thin part may be made larger, whereas a distance from the cabinet surface to the fluid channel in a portion to become a thick part may be made smaller.

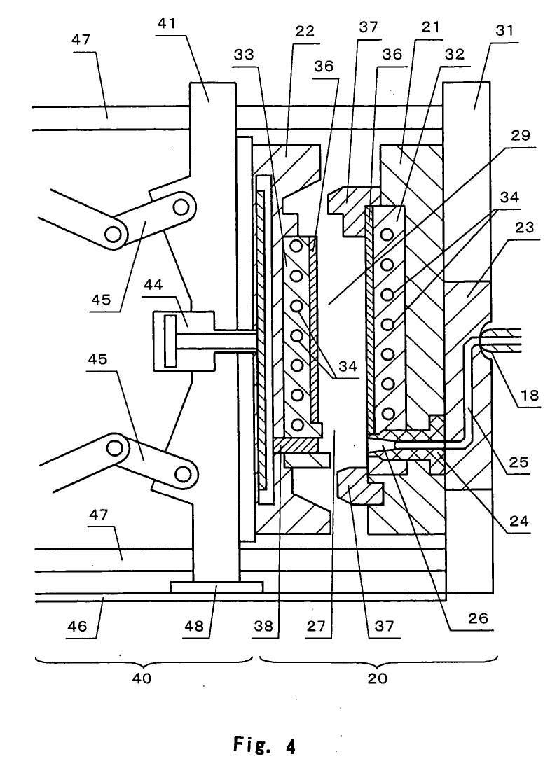

In the case of compressing from the mold side after filling of the resin, an ordinary practice is that a mold is previously open to create a clearance, and under this condition, the molten resin is filled into the cavity. In this case, a connecting face of the fixed mold 21 with a movable mold 22 is preferably a cut-by-press type face with a counter lock structure in order to prevent occurrence of a flash. FIG. 3 shows an example in which sliding cores 37 and 37 are arranged on a connecting face of the fixed mold 21 with the movable mold 22 to form a counter lock structure. Namely, the mold has an angular structure, in which an inclining part of the sliding cores 37 and 37 have the same slope as that of an inclining part of the movable mold 22, and as the movable mold 22 is moved toward the fixed mold 21 to compress the mold, the sliding cores 37 and 37 (end face part of the mold) slide sequentially toward a product cavity to fill a clearance. Conversely, when the mold is opened, the sliding core 37 in contact with a side end of a molded article slides to release the molded article. In this example, the sliding cores 37 and 37 are placed on the side of the fixed mold 21 so as to prevent leakage of the resin from a parting in compressing, with the mold slightly open (see also FIG. 4). An end face of the moving side (periphery of a product) is designed to create a clearance of about 20 to 200 μm, which is a degree of clearance with which no leakage of the resin occurs when the parting is opened by a maximum width of 1000 μm.

Inside the movable mold 22 opposed to the sprue 26, an ejector pin 38 is placed for extruding a molded article when taking it out of the mold. The ejector pin 38 is moved forward or backward by a hydraulic ejector device 44.

A mold cramping device 40 comprises a movable plate 41, a hydraulic cylinder 42 and a hydraulic ram 43 moving forward or backward in the hydraulic cylinder 42. A positioning sensor (not shown) is arranged at a predetermined position between the movable plate 41 and the hydraulic ram 43, to detect a position of the movable plate 41. In the example shown in FIG. 3, upon closing of the mold 20, a molten resin is injection-filled under the condition that the movable plate 41 is opened in a predetermined degree by the positioning sensor, and when an optional set time has been reached, the movable plate 41 is further clamped, and further pressure is thus applied to the molten resin in the mold cavity 29. At this time, additional pressure may be applied from the foregoing ejector pin 38.

Although FIG. 3 shows a hydraulic mold clamping mechanism, a toggle type mechanism, which mechanically clamps with an arm, may also be used. FIG. 4 is a vertical sectional view schematically showing an example of such a case. It is however noted that FIG. 4 shows only the injection nozzle 18 of an injection device and other parts thereof are omitted. Further, FIG. 4 shows the mold 20 in an opened state. Since the mold 20 is similar to that shown in FIG. 3 except that the mold is in an open state and an ejector device 44 is arranged at the center of the movable plate 41, the same reference numerals as those in FIG. 3 are provided to the same parts as those in FIG. 4, and detailed descriptions thereof are omitted.

The mold cramping device 40 shown in FIG. 4 comprises a movable plate 41, a pair of arms 45 and 45 for moving the arms forward or backward, a rail 46 for carrying and moving a movable plate 41, and a pair of tie bars 47 and 47. A lower end of the movable plate 41 is placed on the rail 46 through a base plate 48, and is moved in a clamping direction or mold-opening direction by expansion or contraction of the arms 45 and 45.

Next described is a method for molding a large-sized light transmitting plate with uneven thickness, using a molding machine comprising the injection device 10, the mold 20 and the mold cramping device 40 as shown in FIG. 3 or FIG. 4. First, the mold 20 is closed, and a heating medium is passed though the fluid channels 34 and 34 in the mold 20, to heat the vicinity of the cavity 29 to a predetermined temperature. When clamping the mold 20, it is either fixed with the movable plate 41 completely closed, or temporally cramped with the movable plate 41 opened in a predetermined degree, by a positioning sensor (not shown).

In the case of not using rotational force of the screw in injecting a molten resin, while the screw 12 is rotation-driven by the motor 13, a transparent resin is supplied from the hopper 15 into the injection cylinder 11. The supplied resin is plasticized and melt-kneaded by heat from the heaters 16 and 16 and by heat generated by shearing or friction due to rotation of the screw 12. The resin is then transferred by rotation transfer function of the screw 12 toward the end thereof, and is measured in a predetermined amount. Subsequently, the screw 12 is moved forward by the ram mechanism 14, and the molten resin is injected and flown into the mold. The injected molten resin is transferred continuously toward the cavity 29 through the hot runner 25, the sprue 26, the runner 27 and the gate 28.

On the other hand, in the case using rotation of the screw in filling of the molten resin, under the condition that the screw 12 is present almost at the most forward position, the transparent resin is supplied from the hopper 15 to the injection cylinder 11 while the screw 12 is rotation-driven by the motor 13. The supplied resin is plasticized and melt-kneaded by heat from the heaters 16 and 16 and by heat generated by shearing or friction due to rotation of the screw 12. The resin is then transferred by rotation transfer function of the screw 12 toward the end thereof, and transferred continuously toward the cavity 29 through the hot runner 25, the sprue 26, the runner 27 and the gate 28. At that time, it is preferable to apply back pressure higher than predetermined pressure from the back part of the screw 12 so as to prevent the screw 12 from moving backward by the pressure of the resin transferred toward the front of the screw 12, namely, to keep the screw 12 at such a position. Specifically, back pressure is applied in such an amount that the screw 12 is not moved backward by the pressure of the resin being filled into the cavity, but moved backward by the pressure of the filled resin. In this case advantageously employed is a method, e.g. a flow molding method, in which the molten resin is continuously flowed into the mold cavity 29 while the screw 12 is rotated in the cylinder 11 of the injection device.

In the case where the molten resin is continuously flowed into the mold cavity 29 while the screw 12 is rotated in the cylinder 11, the rotation number of the screw is related to a flow injection rate, and the larger the rotation number, the higher the flow injection rate. The rotation number of the screw is usually selected as appropriate from the range of about 20 to 180 rpm according to conditions such as a diameter of the screw, thickness of a molded article and numbers of the articles molded by one mold. The rotation number of the screw is preferably not more than 150 rpm, and more preferably about 40 rpm. When molding two or more articles using one mold such as two articles, the rotation number of the screw is adjusted so as to obtain a predetermined injection ratio per one molded article.

As described above, a mold surface temperature at the time of flowing of the molten resin is previously set to the vicinity of the glass transition temperature of the resin to be molded, to keep the mold surface temperature not lower than the glass transition temperature of the resin at least until the succeeding holding pressure process is started. Into the cavity of the mold thus heated, a resin melt at a predetermined temperature then starts to be supplied. The back pressure at this time is about 20 to 45 MPa in terms of a resin pressure at the front end of a screw.

Regulation of a mold temperature is described below. The fluid channels 34 and 34 are formed in the interior of the cavity block 32 of the fixed mold 21 and the cavity block 33 of the movable mold 22. A heating medium is passed through the fluid channels 34 and 34 to heat a cavity surface of a mold to a temperature in the vicinity of a glass transition temperature of a resin. For example, in the case of a methacrylic resin, a heating medium such as pressurized water heated to a temperature not lower than 100° C., and specifically about a temperature of 110 to 130° C., is passed through the fluid channels 34 and 34 until the cavity surface is heated to a temperature of about 100° C. When this predetermined temperature is reached, filling of a resin (injection or screw rotation) is started. When the resin is filled under these conditions, a mold surface temperature can be kept at a temperature higher than that before the start of filling, namely, at a temperature not lower than the glass transition temperature of the resin. In the case of methacrylic resin, for example, the mold surface temperature can be kept at a temperature of about 105 to 130° C. This is because a temperature of the resin flowen into the cavity is higher than the cavity surface temperature. After completion of filling, the mold cavities 29 and 29 are rapidly cooled by changing a valve placed on the way of the fluid channels 34 and 34, and passing a coolant having a temperature of about 10 to 40° C., such as water, through the fluid channels 34 and 34. After sufficient cooling, the valve is changed again and as the heating medium is passed through the fluid channels 34 and 34, the mold is opened at a proper temperature thereof, to take out a molded article by extrusion. When a mold temperature is reached a temperature high enough for filling of a resin, the next cycle is started.

In the case of injecting a molten resin with the mold 20 completely closed, a pressure-holding process is started under a condition that the molten resin is sufficiently filled in the cavity 29. Meanwhile, in the case of starting injection of the molten resin with the mold 20 slightly open, or temporarily closed, the pressure-holding process is started under a condition that a cavity 29 is not completely filled, namely, a condition of a short shot. In the latter case, upon start of the pressure-holding process, the mold 20 is gradually and then completely clamped by the movable plate 41, to compress a molten resin in the cavity 29 in the thickness direction thereof, and also to apply proper holding pressure. It is preferable to apply pressure from the cavity surface side after injection simultaneously with application of holding pressure from the injection cylinder side because this leads to reduction in holding pressure itself and allows formation at lower pressure so that mold cramping force for applying pressure from the cavity surface side can be reduced. When a molten resin is continuously flown into a mold cavity while a screw is rotated in a cylinder, the screw 12 is slightly moved backward by pressure of the filled resin, and thereby holding pressure is applied when the screw 12 is moved backward by a predetermined distance.

At the start of application of holding pressure, a medium passing through fluid channels 34 and 34 is changed to a coolant by setting a timer, changing a switch valve or the like. Compression of the mold and holding pressure are maintained for a predetermined time, and a coolant is passed through the fluid channels 34 and 34 such that a surface temperature of a mold cavity at the completion of pressure holding reaches a temperature not higher than a glass transition temperature of a resin. After completion of maintenance of the holding pressure and compression which is performed according to need, the fixed mold 21 and the movable mold 22 are kept closed further for the time required for cooling, for example about 5 to 150 seconds, and preferably about 20 to 80 seconds, depending on the thickness of a product.

After a predetermined cooling time has lapsed and a molded article is cooled to a temperature at which the molded article is not deformed when taken out, the movable mold 22 is opened, and the molded article is taken out by extruding with the ejector pin 38. After taking out the molded article, the medium in the fluid channels 34 and 34 is changed to a heating medium. Upon closing of the movable mold 22, the cavity surface temperature is heated again to a temperature preferably not lower than the glass transition temperature of the resin, and then the next cycle is started to obtain a molded article. It is to be noted that another process may be performed in which the cavity surface is cooled to a temperature lower than a temperature at which a molded article is taken out, a medium in the fluid channels 34 and 34 is changed from a coolant to a heating medium under a condition that a molded article is present in a cavity 29, and then the molded article is taken out in the midst of a temperature rise.

A mold cavity can be arranged to form two or more products (light transmitting plates) to be taken out therefrom. In this case, a molten resin injected from the injection nozzle 18 is passed through the hot runner 25 which is divided into two or more channels at some midpoint thereof, and then the divided molten resin is allowed to flow into each cavity.

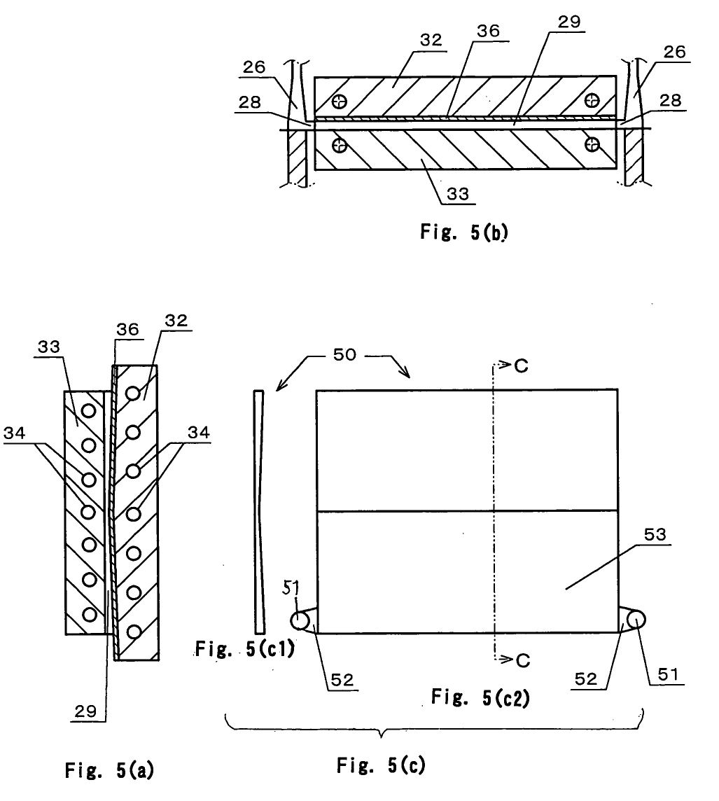

As described above, when there is a large unevenness degree of thickness of a molded article, multipoint gates can be formed. FIG. 5 shows an example of such a case. FIG. 5 shows an example of employing a two-point gate system when, as shown in FIG. 2(b), a light transmitting plate having a figuration that the center line part of the longitudinal direction of one surface is recessed to have the smallest thickness part whereas each longer edge side in parallel with the center line has the largest thickness part (this figuration may be referred to as a “center-recessed wedge shape”). FIGS. 5(a) and 5(b) are a vertical sectional view and a horizontal sectional view of the periphery of the cavity, respectively. FIG. 5(c) is a view showing a light transmitting plate obtained from the above-mentioned mold, where (c1) is a vertical sectional view thereof and (c2) is a front view thereof. (c1) corresponds to a sectional view along the line C-C of (c2). In FIG. 5, the same reference numerals are provided to the same parts as those in FIGS. 3 and 4, and detailed descriptions for those parts are omitted because such descriptions have been given above, and different points from FIGS. 3 and 4 are mainly described here.

In reference to FIGS. 5(a) and 5(b), a movable-side cavity block 32 is formed in an angle-projecting shape having the peak thereof at the center of the longitudinal direction of the molded article. A cavity plate 36 for pattern copying, previously provided with a dot pattern, is bonded to the cavity surface. This surface is on the reaction layer side of the light transmitting plate. On the other hand, the movable-side cavity block 33 has a flat cavity surface (mirror face). The fluid channels 34 and 34 are formed in the interior of the cavities 32 and 33 so that a heat medium and a coolant alternatively pass through the fluid channels 34 and 34. These cavities 32 and 33 are mutually opposed to form the cavity 29. The molten resin is supplied into the cavity 29 to form a light transmitting plate 50 as shown in FIG. 5(c). As shown in FIG. 5(b), the sprue 26 for supplying the molten resin is arranged on each of the right and left shorter edge sides. The molten resin is supplied from the sprue 26 to the cavity 29 through the gate 28. In this example, the gate 28 is provided in the vicinity of the thick part of the light transmitting plate in the lower portion of the mold. The molten resin is supplied from the injection device to the sprue 26 through a hot runner. The hot runner is divided into two channels at some midpoint thereof, though which the molten resin is passed to be sent to the right and left sprues 26 and 26. Although the hot runner and the injection device are not shown in FIG. 5, the configurations thereof can be readily understood by reference to FIGS. 3 and 4.

Further, although the mold also comprises a cavity body for covering the periphery of the cavity blocks 32 and 33, a slide core for forming four peripheral end faces of a molded article by covering the periphery of the cavity 29, those components are not shown in FIG. 5(c1) and FIG. 5(c2). The configurations thereof can also be readily understood by references to FIGS. 3 and 4.

In a light transmitting plate 50 produced using the above-mentioned mold is constituted as follows. As shown in FIG. 5(c1) and FIG. 5(c2), a center-recessed wedge-like light transmitting plate body 53 is formed, and the sprue 51 and the gate 52 are also formed in mutually connected state in two locations of the shorter-edge-side thick parts which are mutually opposed along the length direction of the longer edges. The sprue 51 corresponds to the sprue 26 of the mold, and the gate 52 connected with the sprue 51 corresponds to the gate 28 of the mold. The gate 52 connected with the sprue 51 is cut off after molding.

It is possible to further increase the number of the gates. The multipoint gate system, including the above-mentioned two gate system, is effectively used for allowing the molten resin to sufficiently flow through the thin part even in a light transmitting plate with a large unevenness degree of thickness. Herein described was the example of the case of using the multipoint gate system for production of a center-recessed wedge-like light transmitting plate, as shown in FIG. 2(b), and as for the other types of light transmitting plates shown in FIG. 2, it is also advantageous to provide gates on the symmetry faces in the thick parts of the opposing short edges and then inject the molten resin from those gates. As described above, light sources are generally arranged on the end faces of the long-edge-side thick parts of the light transmitting plate with uneven thickness shown in FIG. 2. This configuration requires the surface to be molded to a mirror face, and hence no gate is desirably formed on that surface. Therefore, gates are generally provided on the shorter edge sides, and the above-mentioned multipoint gate system can be advantageously employed when the molten resin is not sufficiently filled, particularly, into a thin part, due to the use of only one gate placed on the shorter edge side.

The molded article (light transmitting plate) as thus obtained is highly accurate in dimensions and is stable. This is attributed to that a temperature regulating mechanism is provided in the mold, and the molten resin is filled into the cavity, with the cavity surface heated to the vicinity of the glass transition temperature of the resin, and after the filling, the cavity surface is promptly cooled to a temperature lower than the glass transition temperature of the resin. This enables the molten resin to be sufficiently filled, even into the thin part of the light transmitting plate with uneven thickness, resulting in high accuracy in copying of the figuration of the cavity to the product. In the case of continuously allowing a transparent resin to flow into the mold cavity while the screw is rotated in the cylinder, the resin supply process and the injection process are simultaneously performed. In this manner, retention of the molten resin in the injection cylinder is extremely small as compared to a conventional injection molding method, thereby enabling production of a product having further dimensional stability and high transparency. Moreover, the multipoint gate system can be used for example in such a manner that, in a light transmitting plate having the smallest thickness part in the direction parallel with the longer edges thereof, the molten resin is supplied from gates respectively provided in mutually opposing two locations in shorter-edge-side thick parts. This allows the molten resin to be sufficiently filled into the thin part even in the light transmitting plate with a large unevenness degree of thickness. Moreover, forming and copying of a pattern to become a reaction layer or a light diffusion layer on at least one surface of a molded article during the above-mentioned molding method allows omission of a subsequent printing process.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2004-047437 filed on Feb. 24, 2004, including specification, claims, drawings and summary, are incorporated herein by reference in their entirety.

### EXAMPLES

The present invention is described in more detail by following Examples, which should not be construed as a limitation upon the scope of the present invention.

### Example 1

(1) Molding Machine

A molding machine “J450 EL III”, manufactured by “The Japan Steel Works, Ltd.”, was reconstructed and then was used in Example 1. Using the machine, a molten resin is allowed to flow into a mold continuously by transfer function generated by the screw rotation, while a screw is rotated in a cylinder, to obtain a molded article with a pattern formed on the surface thereof. The machine can mold a resin and form a pattern on the resulting molded article. The machine can be switched to conventional injection molding, with an on-off switch arranged thereon. Therefore, a servomotor of the screw is a torque type that can bear rotational load for a long period of time. Further, the molding machine has a regulating system in which a mold temperature can be monitored at all times by a molding-machine regulating system with a temperature sensor placed in a mold cavity. When a requested set temperature is inputted and the mold temperature reaches the input value, a signal is automatically sent to a high pressure type cramping limiter to automatically start the machine operation. Moreover, the machine operation is coupled with an air type valve-switch regulating system for changing a heating medium to and a cooling medium for mold temperature regulation. Upon automatic start of the machine operation, a signal is sent to the valve-switch regulating plate to activate a timer.

In the valve switch regulating system, there are used two improved versions of mold temperature regulating machines “MCN-150H-OM”, a mold cooling machine “MCC3-1500-OM” and a “valve regulating stand”, all manufactured by Matsui MFG. Co., Ltd.,. With a timer set at a predetermined time, when a heating timer is reset after molding has been started, by arranged valve regulation, the cooling medium is automatically supplied, to activate a cooling timer, and when the cooling timer is reset, the heating medium is automatically supplied.

(2) Designing of Mold

A mold was designed for producing a light transmitting plate body, which had an approximate shape to that shown in FIG. 2(b), a diagonal length of 17.9 inches (455 mm) and dimensions of 353 mm (longer edge)×289 mm (shorter edge). Specifically, the mold was prepared so that the plate body had the shape of symmetric wedge with the thickness decreasing from each of the longer edge sides toward the center such that each of the longer edges has the largest thickness part of 8 mm, and the center line in the longitudinal direction had the smallest thickness part of 3 mm. As thus described, one surface of the light transmitting plate was provided with a recess having the deepest part thereof at the center in parallel with the longer edges, whereas the other surface was made flat.

The mold was attached to the above-mentioned molding machine having a mold cramping power of 450 tons. In the molding machine, the mold was arranged to have dimensions capable for molding, to form one molded article. The machine comprises a supply channel for a molten resin having a hot runner structure (see FIG. 3). Gates were respectively placed in two locations symmetric to the center line orthogonal to the longer edges. The periphery of the mold and a light transmitting plate obtained had structures similar to those shown in FIG. 5.

The fixed-side cavity block 32 was obtained as follows. A beryllium-copper alloy having high thermal conductivity, “MP 15”, manufactured by NGK Fine Molds, Inc., was processed to form an angle block having a thickness of 50 mm at the center and 45 mm in parts corresponding to longer edges of an aimed light transmitting plate body. Namely, the horizontally oriented fixed-side cavity surface was processed into a projecting shape having a peak thereof in the centerline part of the longitudinal direction, so as to correspond to a reflection layer side (recessed surface) of the light transmitting plate body. As shown in FIG. 5(a), the fixed-side cavity block 32 protruded from each end side of the cavity 29 in the width direction thereof (the vertical direction in the mold). The beryllium-copper alloy used here was a precipitation hardening alloy, in which beryllium was solid-solved in copper in an amount of not more than 2% by weight, and further a small amount of element such as nickel was added. To the cavity surface, cavity plate 36 for pattern copying, made of a 1.5 mm-thick stainless steel plate, was bonded such that the pattern-formed surface faced outward (the cavity surface). To the cavity plate 36, a perfect-circle-shaped dotted pattern in place of printing had previously been formed by etching. As in the case of the cavity block, the cavity plate 36 for pattern copying was curved into a projecting shape having a peak thereof in the center-line part of the longitudinal direction. The curved cavity plate 36 was fixed with bolts to the cavity block 32 in the parts on the periphery of the cavity block 32 protruding from the end side of cavity surface. The surface to which this cavity plate 36 had been bonded corresponded to a reflection layer side of a final product, light transmitting plate.

Each of the dots in the dotted pattern formed on the surface of the cavity plate 32 were larger at the center of the longitudinal direction, and became smaller with increase of a distance from the center to the thick part (light source side). At the center, the dot had a diameter of about 1.0 mm, and a pitch of about 1.5 mm between the dots. In the light-source side end, the dot had a diameter of about 0.6 mm, and a pitch of about 1.5 mm between the dots. It is to be noted that the dot pattern is not shown in FIG. 5(a) to FIG. 5(c2).

In addition, the movable-side cavity block 33 was obtained as follows. A beryllium-copper alloy, “25A” (corresponding to JIS C 1720), manufactured by NGK Fine Molds, Inc., was processed to have a thickness of 45 mm. This alloy had the highest strength among, and had a higher hardness than the above-mentioned high thermal conductivity-carrying beryllium-copper alloy. The surface of the processed alloy (cavity surface) was plated with nickel to have a nickel thickness of about 100 μm, and further polished by about 25 μm. This plated and polished cavity surface corresponds to an emission surface side of the aimed light transmitting plate.

A sliding core, corresponding to each of side faces of edges provided with no movable-side gate (side face of longer edges of the light transmitting plate) was made of pre-harden steel, “NAK 80”, manufactured by Daido Steel Co., Ltd., and the part corresponding to an end face of a resultant molded article (light transmitting plate) was mirror polished. The mold bodies around those cavity parts were made of a conventional steel material, “S 55 C”. The mold parting face was processed to be inclined in conformity with the molded article. An insulating material having high hardness, manufactured by Misumi Corporation, was bonded to locations with no structural limitation on the parting face, to insulate the cavity block and the slide core from the mold body made of a steel material.

In order to raise or lower a mold temperature during a cycle, a fluid channel 34 having a diameter of about 8 to 12 mm was formed in the interior of each of the fixed-side cavity block 32 and the movable-side cavity block 33, about 8 to 14 mm distance inside from the cavity surface. To each of the fluid channels 34, alternately, cold water as a cooling medium having a temperature of about 15° C. was supplied from a cooling device, and pressurized water as a heating medium having a temperature of about 130° C. was supplied from a temperature-regulation device, to obtain a cooling-heating cycle.

(3) Molding of Resin

Using the molding machine, which had been designed in the above described manner, a methacrylic resin was filled into the mold and was molded, to obtain a light transmitting plate. The molding thereof is described in more detail below.

As the resin material, a transparent methyl methacrylate resin, “SMIPEX MGSS” (transparent), produced by Sumitomo Chemical Co., Ltd., was used, and a temperature of the resin in an injection cylinder was set at 265° C. The rotation number of the screw was set such that an injection ratio was about 19 cm³/sec per one molded article. Here, the injection ratio is expressed by a ratio of a molded article volume (=weight/specific gravity) to the period of time between the start of the filling and the start of pressure holding. The heating medium, heated to 130° C. by the temperature regulating machine, was passed through the fluid channel in the mold, and the molding machine was set to be automatically started when a value indicated by a temperature sensor, placed in the interior of the cavity blocks 32 and 33 made of beryllium-copper, reached about 105° C.

After purging the resin from the hot runner, the movable mold was moved toward the fixed mold to close the molds, and the screw was started rotating to fill the melt methyl methacrylate resin into the cavity formed by both of the movable mold and fixed mold. At that time, while holding the end of the screw at the most front position, the resin was injected into the mold under the screw rotation. The screw holding force was set by back pressure.

Next, when the filling of the resin into the cavity was completed, the screw was gradually moved backward pressed by the pressure of the resin. In a position where the screw was moved backward by about 35 mm, a pressure-holding process was started, while applying holding pressure from the cylinder side. At the point when the screw was started moving backward, the medium in the fluid channel was changed to the cooling medium for cooling the mold. Holding pressure was applied for about 20 to 30 seconds at such a timing that the cavity surface temperature was cooled to about 50 to 60° C. at the completion of holding pressure. Under this condition, cooling was started and the molded article was cooled in the mold for about 60 seconds. After the cooling, the valve was switched with the timer, and the heating medium was allowed to flow through the fluid channel in the mold. The mold was set to be opened at the point when a value indicated by the mold temperature sensor, which had been outputted from the mold, was about 35 to 45° C. After the opening of the mold, the cooled molded article was taken out from the mold. Thereafter, the mold was closed again at low pressure for standby, and the cavity surface temperature was raised continuously. When the value indicated (by the mold temperature sensor, which had been outputted from the mold) was about 105° C., an injection-start signal was sent to the molding machine to start the next cycle.

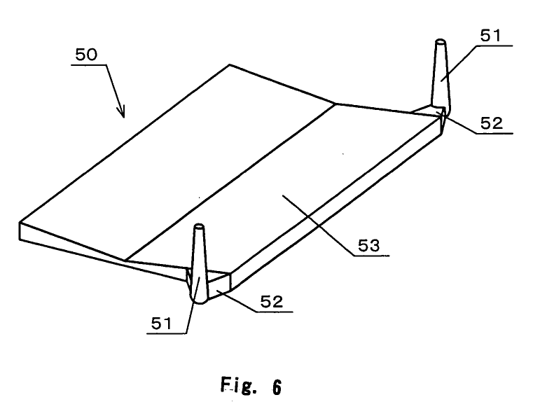

FIG. 6 is an oblique view schematically showing the figuration of the obtained light transmitting plate immediately after being taken out of the mold. However, the dot pattern formed on the recessed surface of the light transmitting plate is omitted here. FIG. 6 corresponds to an oblique view of the light transmitting plate 50, the vertical sectional view and the front view of which are shown in FIG. 5(c). The reference numerals in FIG. 6 are thus the same as those in FIG. 5(c), and hence explanations of those are omitted. It is to be noted that the part where the sprue 51 is connected with the gate 52 is cut off after the molding. The obtained light transmitting plate has superior dimensional accuracy, good appearance, a rough pattern thereon which was accurately copied from the cavity surface, and a small amount of warping.

### Reference Example 1

Using the same mold as that in Example 1, a light transmitting plate was produced by conventional injection molding, in which a resin was measured and retained in a cylinder of an injection molding device, and then injected. Herein, a mold temperature was kept at 85° C. As a result, a weld line occurred at the center of the product caused by arrangement of two-point gates, and abnormal emission was observed in a final luminance evaluation, whereby the light transmitting plate was determined as defective. Further, copy performance of pattern varies and a large amount of sink occurs, whereby the product was found non-usable as a light transmitting plate. In this case, since a large amount of resin was retained in the cylinder, yellowing of the resin occurs, degrading transparency to result in low final luminance performance.

1. A method for producing a light transmitting plate, the method comprising the steps of:
(1) connecting a cylinder of an injection device with a cavity in a mold having a diagonal length of not smaller than 14 inches (355 mm);
the mold having (i) a space with a non-uniform height corresponding to a thickness of the plate with a ratio of the largest thickness to the smallest thickness of the plate in the range of 1.1 to 8, and (ii) comprising a mold body and a cavity block for forming a cavity surface,
the cavity block having a thermal conductivity higher than that of the mold body, and having a fluid channel in the interior thereof,
the fluid channel being connected with a fluid switching means for changing a fluid medium to be passed therethrough, and allowing a heating medium and a cooling medium to pass alternately through the fluid switching means, to regulate a temperature of the mold,
(2) passing the heating medium through the fluid channel so as to heat the cavity surface to a temperature in the vicinity of or higher than a glass transition temperature of a resin to be filled into the cavity, and also so as to heat the cavity surface to a temperature of not lower than the glass transition temperature when the supply of the resin is finished;
(3) supplying the resin to the cylinder and melting the resin;
(4) filling the molten resin into the cavity; and
(5) passing the cooling medium through the fluid channel after the filling of the cavity, to cool the cavity surface to a temperature lower than the glass transition temperature of the resin, thereby to obtain a light transmitting plate with an non-uniform thickness.

2. The method according to claim 1, wherein the smallest thickness of the plate is not less than 2 mm, and the largest thickness of the plate is in the range of from 5 mm to 16 mm.

3. The method according to claim 1 or 2, wherein a ratio of the largest thickness to the smallest thickness of the plate is not less than 2.

4. The method according to claim 1, wherein the cavity block comprises a copper alloy containing beryllium.

5. The method according to claim 1, wherein the mold has at least two gates to serve as inlets for filling the molten resin into the cavity.

6. The method according to claim 5, wherein the cavity has a rectangular-plate shape with non-uniform thickness, the smallest thickness part of the cavity is formed in parallel with the longer sides of the cavity, and two gates for filling the molten resin into the cavity are respectively provided so as to face each other at the thick parts of the shorter sides of the cavity.

7. The method according to claim 6, wherein the smallest thickness part of the cavity is formed along with the center line in parallel with the longer sides of the cavity.

8. The method according to claim 1, wherein at least one of the mold cavity surfaces has a rough pattern to form the rough pattern on the light transmitting plate.

9. The method according to claim 8, wherein a cavity plate having a rough pattern on its surface is arranged on at least one of the cavity surfaces to provide the rough pattern on the at least one of the mold cavity surfaces.

10. The method according to claim 1, wherein a screw is arranged in the cylinder of the injection device, and the molten resin is filled into the mold cavity while rotating the screw.

11. The method according to claim 1 or 2, wherein the cavity surface is heated prior to the filling of the resin, to have a temperature between a temperature lower by 25° C. than the glass transition temperature of the resin and a temperature higher by 25° C. than the glass transition temperature of the resin.

12. The method according to claim 1, wherein the mold is cooled after the filling of the molten resin, by applying holding pressure from the cylinder side or by compressing from the mold side, or by both applying holding pressure from the cylinder side and compressing from the mold side.
